(19) United States
(12) Patent Application Publication
(10) Pub. No.: US 2025/0237187 A1
(43) Pub. Date: Jul. 24, 2025

(54) VEHICLE REMOTE START REQUEST

(71) Applicant: Ford Global Technologies, LLC, Dearborn, MI (US)

(72) Inventors: Victor Martinez, Novi, MI (US); Brendan Francis Diamond, Grosse Pointe, MI (US); Keith Weston, Canton, MI (US); Jonathan Hair, Northville, MI (US)

(73) Assignee: Ford Global Technologies, LLC, Dearborn, MI (US)

(21) Appl. No.: 18/417,462

(22) Filed: Jan. 19, 2024

(51) Int. Cl. F02N 11/08; F02D 29/02

(52) U.S. Cl. CPC F02N 11/0807; F02D 29/02; F02N 11/0811; F02N 2200/08; F02N 2200/123

(57) ABSTRACT

A system includes a computer including a processor and a memory storing instructions executable by the processor to determine to disable a remote start request in a vehicle based on a current state of the vehicle. In response to disabling the remote start request, the instructions include to output a notification. Then, upon receiving a user input to override the disabling of the remote start request, the instructions include to actuate one or more vehicle components as specified by the remote start request.

### BACKGROUND

A vehicle may be equipped with a remote start feature with which a user may request to start the vehicle from outside of the vehicle, e.g., from inside the user's home or office, using a remote device, e.g., a key fob or a mobile phone. In some cases, a user may schedule remote start requests for the vehicle to start at a designated or predetermined time.

### BRIEF DESCRIPTION OF THE DRAWINGS

FIG. 1 is a block diagram of components of a vehicle, including components for implementing a remote start system.

FIG. 2 illustrates a first example vehicle location for a remote start request.

FIG. 3 illustrates a second example vehicle location for a remote start request.

FIG. 4A illustrates a third example vehicle location for a remote start request.

FIG. 4B illustrates a fourth example vehicle location for a remote start request.

FIG. 5 is a process flow diagram of an example process for the remote start system.

### DETAILED DESCRIPTION

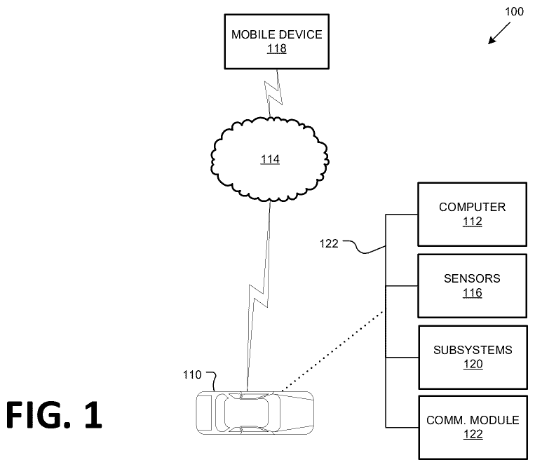

With reference to FIG. 1, a vehicle system 100 may be provided to manage a remote start of a vehicle 110, including receiving a remote start request and initiating or preventing a remote start in response to the remote start request. A “remote start request” is a request sent to a vehicle computer 112 from a location that is remote from the vehicle 110, i.e., outside of and some distance from the vehicle 110, to start the vehicle 110. Starting a vehicle 110 means activating a vehicle power and/or propulsion system, i.e., activating the vehicle to a state where the vehicle can be actuated to move, e.g., activation of one or more of an internal combustion engine, electric motor, hybrid propulsion, vehicle heating, ventilation and air conditioning (HVAC), etc. The system 100 may include one or more remote devices 118 for communication with the vehicle 110. In some examples, the one or more remote devices 118 may be in communication with the vehicle 110 over a network 114, e.g., a local area network (LAN) such as a WiFi® network or the like, and/or a wide area network (WAN), e.g., including cellular communications and/or the Internet. For example, a user of the one or more vehicles 110 may, via the remote device 118, send the remote start request over the network 114 to start the vehicle 110 from a location remote from the vehicle 110. Sensors 116 of the vehicle 110 may detect a current state of the vehicle 110 and, based on the current state of the vehicle 110, the vehicle computer 112 may determine that the remote start request should be disabled. In some implementations, a notification or a message may be provided to the user of the vehicle 110 to allow the user of the vehicle 110 to override the disabling of the remote start request.

A system includes a computer including a processor and a memory storing instructions executable by the processor to determine to disable a remote start request in a vehicle based on a current state of the vehicle. In response to disabling the remote start request, output a notification and then, upon receiving a user input to override the disabling of the remote start request, actuate one or more vehicle components as specified by the remote start request.

The instructions may further include instructions to identify a user of the vehicle based on the current state of the vehicle.

A method includes determining to disable a remote start request in a vehicle based on a current state of the vehicle. In response to disabling the remote start request, the method includes outputting a notification of a specified time and then, upon receiving a user input to override the disabling of the remote start request, actuating one or more vehicle components as specified by the remote start request.

The method may include identifying a user of the vehicle based on the current state of the vehicle.

The specified time may be determined based on the current state.

The current state of the vehicle may include a vehicle location.

The vehicle location may be an indoor location.

The vehicle location may be within a geofenced area.

The current state of the vehicle may include a suspension height of the vehicle.

The current state of the vehicle may include an exterior component status of the vehicle.

The current state of the vehicle may include a wheel attachment status.

The user input to override the disabling of the remote start request may be within a specified time.

Accordingly, a system 100 for the vehicle 110 includes the vehicle computer 112 including a processor and a memory storing instructions executable by the processor to determine to disable a remote start request in a vehicle 110 based on a current state of the vehicle 110. In response to disabling the remote start request, the instructions can include to output a notification or message that the user can, typically for a specified time, override the disabling of the remote start request. The message may be output to a remote device for input by a user of the remote device and the notification may be available for input by the user for the specified time. Then, upon receiving a user input to override the disabling of the remote start request within the specified time, the instructions include to actuate one or more vehicle components as specified by the remote start request.

The system 100 may be provided any suitable type of ground vehicle, e.g., an electric cart, a warehouse vehicle such as a forklift, a passenger or commercial or consumer vehicle such as a sedan, a coupe, a truck, a sport utility, a crossover, a van, a minivan, a taxi, a bus, a motorcycle, etc.

The vehicle computer 112 includes a processor and a memory such as are known, and may communicate via a vehicle network 122. The vehicle computer 112 may be a generic computer with a processor and memory as described above and/or may include an electronic control unit (ECU) or controller for a specific function or set of functions. Alternatively or additionally, in cases where the vehicle computer 112 actually comprises a plurality of devices, the vehicle network 122 may be used for communications between devices represented as the vehicle computer 112 in this disclosure. Further, as mentioned below, various controllers and/or sensors 116 may provide data to the vehicle computer 112 via the vehicle network 122.

A vehicle network 122 may include a conventional vehicle communications bus such as a CAN bus, LIN bus, etc., and/or could include other wired and/or wireless technologies, e.g., Ethernet, Wi-Fi®, cellular, Bluetooth®, Bluetooth® Low Energy (BLE), etc. Accordingly, a vehicle computer 112, ECU, etc., may transmit messages to various devices in the vehicle 110 and/or receive messages from the various devices, e.g., ECUs, controllers, actuators, sensors 116, etc.

The vehicle sensors 116 may communicate on the vehicle network 122 with various vehicle components such as the vehicle computer 112. A sensor 116 is a device that may obtain one or more measurements of one or more physical phenomena interior or exterior to the vehicle 110. Some sensors 116 detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. Sensor operation may be affected by obstructions, e.g., dust, snow, insects, etc. Often, but not necessarily, a sensor 116 includes a digital-to-analog converter to convert sensed analog data to a digital signal that may be provided to a digital computer, e.g., via a network 122. Sensors 116 may include a variety of devices, and may be disposed to sense vehicle environmental conditions, provide data about a machine, etc., in a variety of ways. The vehicle sensor 116 could be mounted in or on a vehicle 110. Further, other sensors, in or on a vehicle 110 could include cameras, short range radar, long range radar, LIDAR, and/or ultrasonic transducers, weight sensors, accelerometers, motion detectors, etc., i.e., sensors 116 to provide a variety of data. Some vehicle sensors 116 detect internal states of the vehicle 110, for example, wheel speed, wheel orientation, and engine and transmission variables. Some sensors 116 detect the position or orientation of the vehicle 110, for example, global positioning system (GPS) sensors 116; accelerometers such as piezo-electric or microelectromechanical systems (MEMS); gyroscopes such as rate, ring laser, or fiber-optic gyroscopes; inertial measurements units (IMU); and magnetometers. Moreover, various controllers in the vehicle 110 may operate as sensors 116 to provide data via the vehicle network 122 or bus, e.g., data relating to vehicle speed, location, subsystem 120 and/or component status, etc. To provide just a few non-limiting examples, sensor data could include data for determining a position of the vehicle 110, a position of one or more vehicle components, a location of an object, a speed of an object, a type of an object, a slope of a roadway 124, a temperature, a presence or amount of moisture, a fuel/oil level, a data rate, etc.

The vehicle subsystems 120 may include a location subsystem. The location subsystem may be implemented via circuits, chips, or other electronic components that may determine a present location of the vehicle 110. The location subsystem may be implemented via a satellite-based system such as the Global Positioning System (GPS). The location subsystem may triangulate a location of the vehicle 110 based on signals received from various satellites in the Earth's orbit. A “location” in the context of this document is a position on the surface of the earth that can be represented in a coordinate system such as geo-coordinates determined by global navigation satellite system (GNSS) receivers and/or some other coordinate system, such as a local coordinate system for an area. The location subsystem can be programmed to output signals representing the present location of the vehicle 110, e.g., the vehicle computer 112 via the vehicle network 122. For example, the present location of the vehicle 110 may be a stored location, a location within geofenced areas 132, etc.

A vehicle computer 112 could use any suitable technique to determine a vehicle location. Further, in examples where the remote start system 100 is implemented inside a building or structure, the navigation system could use an indoor positioning system (IPS) that could include various suitable mechanisms to allow the vehicle computer 112 to determine a location of the vehicle 110. For example, a vehicle computer 112 could detect or receive an electronic signal over the network 114, such as Wi-Fi, Bluetooth, ultra-wideband, etc., and/or could detect landmarks provided in a travel area of the vehicle 110, such as magnets, QR codes, infrared-visible markers, etc. Location data provided by the location subsystem may be provided when the vehicle 110 is not in use, e.g., parked and in a non-started state, and/or when the vehicle 110 is in an operating state, e.g., moving, to determine the location of the vehicle 110. For example, a computer 112 may receive a signal or communication via a network associated with a location, e.g., a specified garage or other parking location, e.g., via a Wi-Fi® or other local area network. alternatively or additionally, a vehicle camera sensor 116 could scan a QR code or the like, and/or could detect a marker or landmark, etc., that programming of the computer 112 associates with a location and/or determines is associated with a location based on data provided from a remote computer server (not shown) via the network 114, e.g., according to QR code technology.

The propulsion system included in vehicle subsystems 120 may include one or more of an internal combustion engine, electric motor, a hybrid propulsion including an internal combustion engine and one or more electric motors, etc.

A vehicle communication module (not shown) may communicate on the vehicle network 122 with various vehicle components such as a vehicle computer 112, vehicle sensors 116, etc., and may communicate via wireless communications with entities outside the vehicle 110. The vehicle communication module 122 may include, e.g., through a vehicle-to-vehicle (V2V) or vehicle-to-infrastructure or everything (V2X), vehicle-to-everything including cellular vehicle-to-everything (CV2X) wireless communications (cellular and/or DSRC., etc.) to another vehicle, and/or to a remote server (not shown). The vehicle communication module 122 could include one or more mechanisms for communication with other devices including any desired combination of wireless (e.g., cellular, wireless, satellite, microwave and radio frequency) communication mechanisms and any desired network topology (or topologies when a plurality of communication mechanisms are utilized). Exemplary communications provided via the module may include cellular, Bluetooth, IEEE 802.11, dedicated short range communications (DSRC), cellular V2X (C-V2X), and the like.

A remote start request can be sent to the vehicle computer 112 from a remote device 118. A “start” to the vehicle 110, in the context of this disclosure, may be any operation that allows the vehicle 110 propulsion to operate, vehicle heating, ventilation and air conditioning (HVAC), etc. For example, a “start” may include activation of one or more of an internal combustion engine, electric motor, hybrid propulsion, etc.

After receiving a remote start request, the vehicle computer 112 may send a signal to the remote start system 100 to start the vehicle 110. For example, the remote device 118 may be a mobile or portable device such as a key fob associated with the vehicle 110, or a portable computing device such as a smartphone or tablet; examples are also possible in which the remote device 118 is a desktop and/or laptop computer, etc.

The remote device 118 may be any suitable device that provides a user interface, e.g., a graphical user interface (GUI), to allow a user to provide inputs. The remote device 118 may have the capability to allow a user to initiate and/or schedule remote start requests. For example, the user may use an application downloaded to the remote device, e.g., an application provided by a vehicle original equipment manufacturer, such as FordPass®, may provide remote start initiation and/or scheduling capabilities, and could further be extended or modified to support operations as described herein.

In some examples, the remote start request may be a “real-time” remote start request. In such an example, a user may provide input to send the remote start request at the time they want to initiate a remote start. For example, a user could press a button on a key fob or make a selection in a remote device application to immediately send the remote start request. In other examples, the remote start request may be scheduled to be sent to the vehicle computer 112 at a specified time. In other words, the remote start request may be scheduled for some time in the future, not immediately. In such an example, a user may choose in the remote device application a specific time in the future to send the remote start request to the vehicle computer 112.

Upon receiving the remote start request, the vehicle computer 112 can determine the current state of the vehicle 110. A “current state” of a vehicle means a set of values that describe one or more current conditions of the vehicle and/or an environment around the vehicle. The current state of the vehicle 110 may be determined based on data from one or more vehicle sensors 116. The current state of the vehicle provides the vehicle computer 112 with data indicating whether the remote start request sent to the vehicle 110 should disabled. In some examples, the current state of the vehicle 110 may indicate that the remote start request may be enabled (or not disabled). In such an example, enabling the remote start request allows the user to start the vehicle 110 when the user is remote from the vehicle 110 The distance from the vehicle 110 may vary based on the location of the vehicle 110 relative to the user and/or the remote device. In other examples, the current state of the vehicle 110 may indicate that the remote start request may be disabled. In such an example, disabling the remote start request prevents the vehicle 110 from starting unless another condition, e.g., an override input being provided, is met.

Below are non-limiting examples of current states that may be evaluated by the vehicle computer 112 in determining whether to disable the remote start request. Table 1 includes a list of examples of current states of the vehicle example types of data that may be used to determine the current state. Such information is further described following Table 1.

TABLE 1
Examples of Current States and Data to Determine Current States

| Current | Example | Example Data |
|---|---|---|
| State | Data Types | Values and Results |
| Location | Location data | Home Garage (Indoors) = |
| | (camera data, | Disable Remote Start |
| | LIDAR data, stored | Request |
| | location data, indoor | Service Center (Stored) = |
| | location data, | Disable Remote Start |
| | geofencing, remote | Request |
| | device data, etc.) | Distance Between |
| | | User and Vehicle > |
| | | Threshold = Disable |
| | | Remote Start Request |
| | | Home Driveway (Outdoors) = |
| | | Enable Remote |
| | | Start Request |
| Exterior | Wheel attachment | Wheel Not Attached = |
| Component | status | Disable Remote Start |
| | | Request |
| Suspension | Distance from | Suspension Height > |
| Height | the roadway | Threshold = Disable |
| | | Remote Start Request |
| Component | Fluid levels, | Levels > OR < Threshold = |
| Level | pressure levels, | Disable Remote |
| | temperature levels | Start Request |
| User | Camera data, | User Identified = Disable |
| Identification | biometric data, | Remote Start Request |
| | remote device data | OR Enable Remote Start |
| | | Request (Depends on |
| | | The Identified User) |

As an example, the current state of the vehicle 110 may include a location of the vehicle 110, i.e., a vehicle location. The location of the vehicle 110 could be determined based on GPS data, data from vehicle sensors 116 sensing exterior vehicle environmental conditions of the vehicle 110, e.g., cameras, LIDAR, etc., or any other suitable data from any other suitable vehicle sensors 116. For example, as described above, a vehicle computer 112 could use camera sensor 116 data to obtain an image of a marker or indicia, e.g., a QR code or the like, that could indicate a vehicle location. In other words, the vehicle sensors 116 may sense the external world to determine the current state based on the location of the vehicle 110.

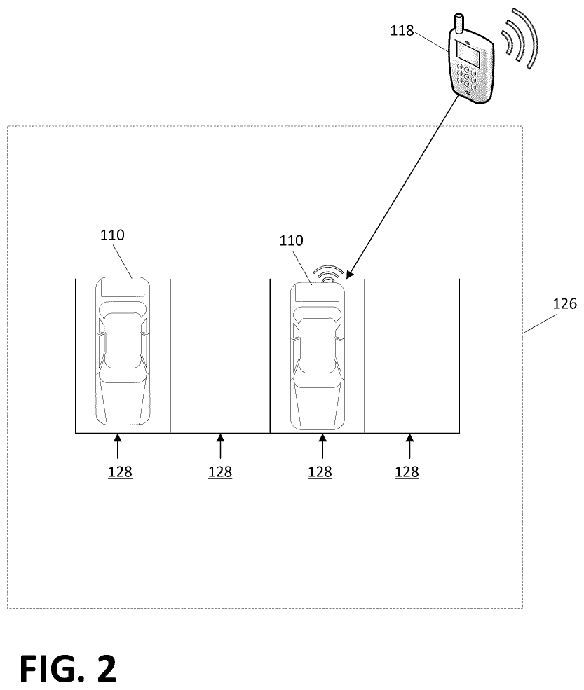

A determination whether to disable a remote start capability can be based on a vehicle location included in the vehicle current state. For example, when location data indicates a location of the vehicle 110 that is within an area 126 of a map indicated to be an open space, e.g., outside in a parking lot, driveway, parking garage, etc., a remote start request not be disabled when the vehicle computer 112 receives a remote start request. An “open space” herein means a space that is not fully enclosed, e.g., a space that is outdoors or a space that is not fully in an enclosed structure (e.g., a car parked location with an overhead covering but with no walls or with walls that do not completely surround a parked vehicle). In the example shown in FIG. 2, the vehicle 110 is parked in a parking space 128 that is in an area 126, e.g., an open space and the remote start request accordingly would not be disabled based on determining the location in the area 126.

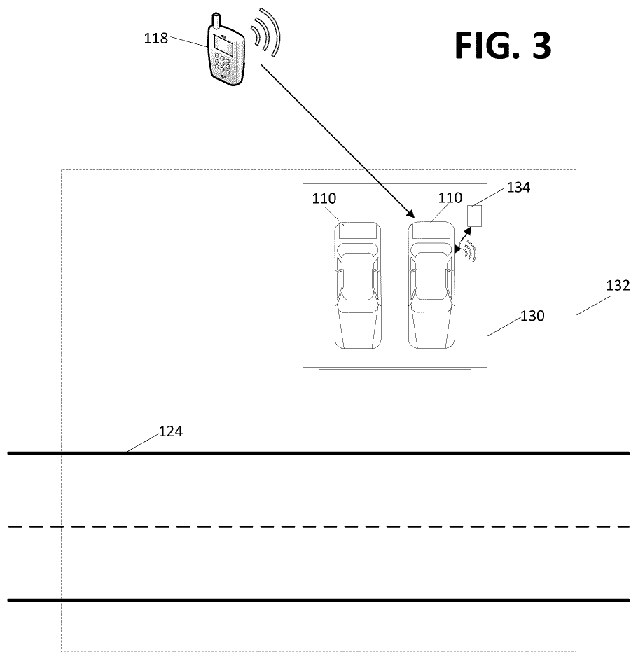

With reference to FIG. 3, in other examples, when the location data shows the vehicle 110 is in a location which is determined to be not suitable for a remote start request, the vehicle computer 112 may disable the remote start request based on the determined location. Locations such as vehicle dealerships, service centers, at-home garages, or any other suitable location that may be an indoor location, may be examples of locations where the remote start request may be disabled.

With continued reference to FIG. 3, with regard to the current state being determined based on vehicle sensors 116 sensing exterior vehicle environmental conditions, cameras or other sensors 116 may identify the exterior vehicle environmental conditions. As an example, the vehicle sensors 116 may identify that the vehicle 110 is located in an indoor location, e.g., a structure 130. In such an example, the remote start request may be disabled based on determining that the vehicle 110 is indoors. The vehicle sensors 116 may identify characteristics of an indoor location such as walls, windows, tools, equipment, markers such as QR codes or the like, etc., to determine that the remote start request may be disabled using conventional image recognition techniques, training a neural network, etc. In the example shown in FIG. 3, the vehicle 110 is parked inside a structure 130, e.g., an indoor location, and the remote start request may be disabled because the vehicle 110 is identified as being inside the structure 130.

With regard to the current state being determined based on GPS data, the location of the vehicle 110 may be determined based on a geofenced area 132. A “geofenced area 132” is an area specified by geo-coordinates, e.g., a rectangle or other polygon with corners defined by respective coordinate pairs. A geofenced area can be defined within which a vehicle 110 may operate and/or can perform specified operations, e.g., move at or below a specified speed, etc. A geo-fenced area can be defined based on various features on a ground surfaces, e.g., for a roadway or a segment thereof, a radius from predetermined/stored locations/buildings, an area covered by predetermined/stored locations/buildings, etc. In the example shown in FIG. 3, in addition to the vehicle 110 being parked inside a structure 130, the vehicle 110 is located inside a geofenced area 132. In such an example, when the vehicle 110 is within the geofenced area 132, a remote start request may be disabled.

As another example, a distance between the vehicle location and the user may be used in determining whether to enable or disable the remote start request. For example, location data, e.g., GPS data, from the remote device 118 may be used in determining whether a user is within a threshold distance of the vehicle 110. A location of the remote device 118 may be compared to the location data, e.g., GPS data, of the vehicle 110 and, if the distance between the vehicle 110 and the remote device 118 is greater than a threshold distance, the remote start request may be disabled. If the distance between the vehicle 110 and the remote device 118 is less than a threshold distance, the remote start request may be enabled.

In addition to identifying that a vehicle 110 is indoors, the vehicle sensors 116 may sense other phenomena to determine a current vehicle state. For example, the vehicle sensors 116 may sense whether exterior components of the vehicle 110 are attached to the vehicle 110 and in a position to support the vehicle 110 and/or for movement of the vehicle 110. Such components may include the wheels 134 of the vehicle 110. The wheels 134 may be identified as not being attached to the vehicle, e.g., the wheels 134 may be identified as being spaced from the vehicle 110. In other words, the wheels 134 may be spaced from the vehicle 110 by such a distance that it would be impossible for the wheels 134 to be attached to the vehicle 110; for example, the wheels 134 could be more than a maximum allowed suspension height away from the vehicle 110. In addition to the vehicle sensors 116, tags associated with each of the wheels 134, such as Radio Frequency Identification (RFID) tags, may also indicate that wheels 134 are not within a threshold distance of the vehicle 110, and that therefore the wheels 134 may not be attached to the vehicle 110. An RFID reader may be used to determine that the RFID tags associated with the wheels are within range of the RFID reader or that the wheels are within a threshold distance of the vehicle. The vehicle 110 and/or the tags may provide a wheel attachment status. The wheel attachment status provides to the vehicle computer 112 with sensor data regarding whether the wheels 134 are attached to the vehicle 110 or not attached to the vehicle 110. In examples where the vehicle sensors 116 or component tags identify that the wheels 134 or other exterior components are not attached to the vehicle 110, the remote start request may be disabled. In the example shown in FIG. 3, a wheel 134 of the vehicle 110 is not attached to the vehicle 110 and is spaced from the vehicle 110 such that the remote start request may be disabled.

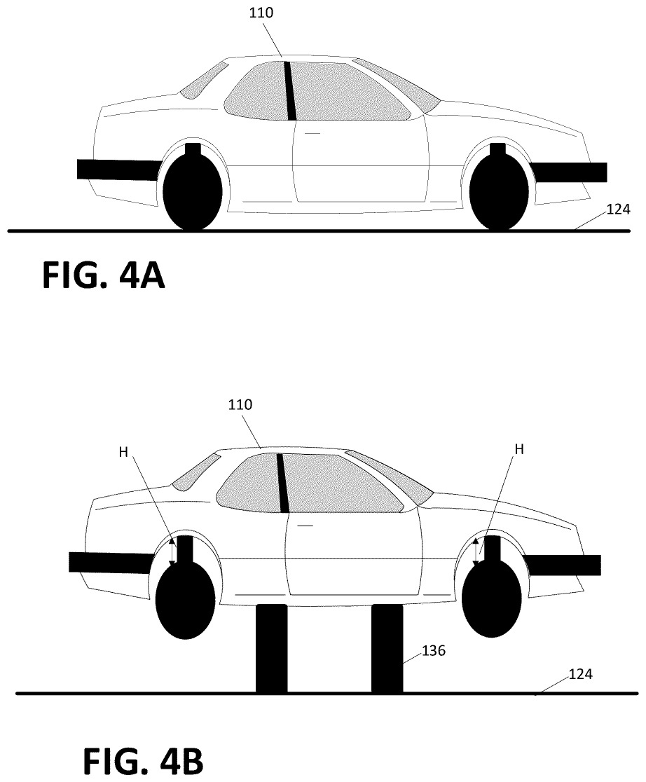

With reference to FIGS. 4A and 4B, as another example, the vehicle sensors 116 may identify vehicle conditions that may disable the remote start request. An example of a vehicle condition may be suspension height H, or ride height, of the vehicle 110. In such an example, when a vehicle 110 is suspended on a hoist 136, e.g., for servicing, the suspension height H is typically greater than when vehicle wheels are resting on a ground surface and supporting the vehicle 110. Using vehicle design information and/or data from empirical testing, a predetermined height threshold can be established, where a determination of a height H above threshold can be interpreted to mean that the vehicle is on a hoist or suspension apparatus. If the distance between the wheel 134 and the remainder of the vehicle 110 is greater than a predetermined threshold, the remote start request may be disabled. In the examples shown in FIG. 4A, the vehicle 110 is not suspended above the roadway 124, i.e., the wheels 134 of the vehicle 110 are contacting the roadway 124. In the example shown in FIG. 4B, the wheels 134 are spaced upwardly from the roadway 124 because the vehicle 110 is suspended from a hoist 136 for service. Thus, the suspension height H is greater in FIG. 4B than the suspension height H in FIG. 4A and may exceed the predetermined height threshold.

Other examples of vehicle conditions used to determine the current state of the vehicle 110 may include fluid levels, pressure levels, and/or temperature levels of certain components in the vehicle 110. Fluid levels may include fluids such as fuel, oil, or any other suitable fluid of the vehicle 110. When the fluid levels are outside an upper threshold or a lower threshold, the remote start request may be disabled. The fluid levels may be measured by vehicle sensors 116 associated with a particular fluid. Pressure levels may include pressures of fluids such as fuel, oil, or any other suitable fluid of the vehicle 110. When the pressure levels are outside an upper threshold or a lower threshold, the remote start request may be disabled. The pressure levels may be measured by vehicle sensors 116 associated with a particular fluid. In the example of vehicle that uses an electric motor for propulsion, a temperature of a battery such as a traction battery may be measured. If the temperature of the battery is above a certain temperature, the remote start request may be disabled. The temperature may be measured by vehicle sensors 116 associated with the battery.

Vehicle sensors 116 may be used to identify users of the vehicle 110. For example, cameras of the vehicle 110, either interior to the vehicle 110 or exterior to the vehicle 110 may identify a user and enable or disable the remote start request based on the user identity, e.g., biometric data such as facial recognition, fingerprint recognition, or other suitable types of biometric data could be used to determine a user identity which in turn could be used to determine whether the user is authorized to start the vehicle.

The current state of the vehicle 110 may be determined based on input provided by a user of a remote device 118. For example, a remote start request may be disabled based on user input to disable the remote start request and/or based on user input or stored data associated with a current state indicating that the remote start request should be disabled. As an example, the user may schedule a service appointment through an application on the remote device 118, e.g., an application such as FordPass® could be modified or extended to allow such user operations. During such an appointment, the remote start request may be disabled such that the vehicle 110 will not start during the service appointment; that is, the computer 112 could include programming to disable any remote start request received at a time when a service appointment is scheduled. In an example where the remote device 118 is a key fob, the user may program the key fob to be associated with particular users of the vehicle 110. For example, the key fob may be associated with, i.e., a vehicle computer 112 could be programmed to associate the key fob with, a service location, a service technician, a valet user, family members of the user, or any other suitable association. In such examples, features of the vehicle 110 may be enabled or disabled based on detecting a key fob, e.g., an identifier of the key fob, and determining the vehicle 110 features to enable to disable could be based on an identity of a user with whim the key fob is associated, a location associated with the key fob, etc., For example, a remote start request could be disabled based on identifying a key fob in or near the vehicle 110 that is associated with a certain user.

As another example, the vehicle sensors 116 may identify a person, e.g., a service technician or other user, standing near (e.g., within a distance such as five or ten feet) the vehicle 110 for a predetermined period of time and/or could detect use of tools on the vehicle 110, e.g., connection to a service port such as an OBD port or the like. The person may be identified by using conventional image recognition techniques, training a conventional neural network, stored image data, stored biometric data related to different persons, etc. In such examples in which a vehicle service scenario can be determined to be occurring, a remote start request may be disabled.

The above-described current states could be evaluated individually or together with one or more other current states to determine whether a remote start request is to be disabled. As an example, the location of the vehicle, e.g., the vehicle being located at a service center for servicing, could be used individually to determine the current state of the vehicle. As another example, the suspension height may be used in combination with camera data identifying a service technician adjacent the vehicle to determine the current state of the vehicle. Any other suitable combination may be used based on the remote start request.

In the event that a remote start request is sent to the vehicle computer 112 and the current state of the vehicle 110 indicates that the remote start request is to be disabled, a notification or message may be output by the vehicle computer 112 to the user to determine whether to override the disabling of the remote start request. In other words, in some implementations, a user is able to override the disabling of the remote start request to allow the vehicle 110 to start remotely. The notification may prompt a user for an input as to whether to override the disabling of the remote start request.

As an example, the vehicle computer 112 may transmit a notification to the remote device 118 or an application on a remote device 118. The notification may appear on a user interface of the remote device 118. The notification may request user input concerning whether to override a disabling of a remote start request, e.g., the user interface of the device 118 could include an option of “yes” to override the disabling and “no” to not override the disabling. When the user input is “yes,” the remote start request can be overridden and the remote start request enabled. When the user input is “no” in this example, the remote start request is not overridden and the remote start request is disabled, i.e., the vehicle 110 would be disabled or prevented from starting. In other examples, the notification may be output to any suitable interface such that a user may receive the notification, e.g., a user interface inside the vehicle 110, etc.

A user can be foreclosed or prevented from responding to the notification after a predetermined amount of time (or a “specified time”), i.e., user input responding to the notification will not be accepted after the predetermined amount of time. The specified time can be based on empirical testing or simulation to specify how long a user typically needs to review a notification and respond to it and/or to prevent starting a vehicle after conditions defining the current state of the vehicle may have changed. Further, the specified time may be dynamically selected or varied based on the current state of the vehicle 110 or any other suitable condition of the vehicle 110. For example, the specified time may be different based on the location of the vehicle, the identified user of the vehicle, or any other characteristic described herein that is used to determine the current state of the vehicle. If the user does not provide input responding to the notification within the specified time, the remote start request in some implementations will default to being disabled. On the other hand, if the user provides an input to respond to the notification within the specified time, the remote start request can be enabled, i.e., the disabling of the remote start request is overridden.

Upon receiving the user input to override the disabling of the remote start request within the specified time, one or more vehicle components specified by the remote start request can be actuated. The remote start request described herein includes sending a request to start a vehicle and power components that are used in normal operation of the vehicle, e.g., the propulsion, vehicle heating, ventilation and air conditioning (HVAC) of the vehicle is typically activated to an “on” state by a remote start request.

When the remote start request is disabled, in some implementations, the vehicle computer 112 may be programmed to receive and evaluate a second remote start request, e.g., in a manner such as that just described for a first remote start request. For example, after a period of time, a new, i.e., second, remote start request may be sent by the user. In such an example, the system 100 may have been reset to receive the second remote start request.

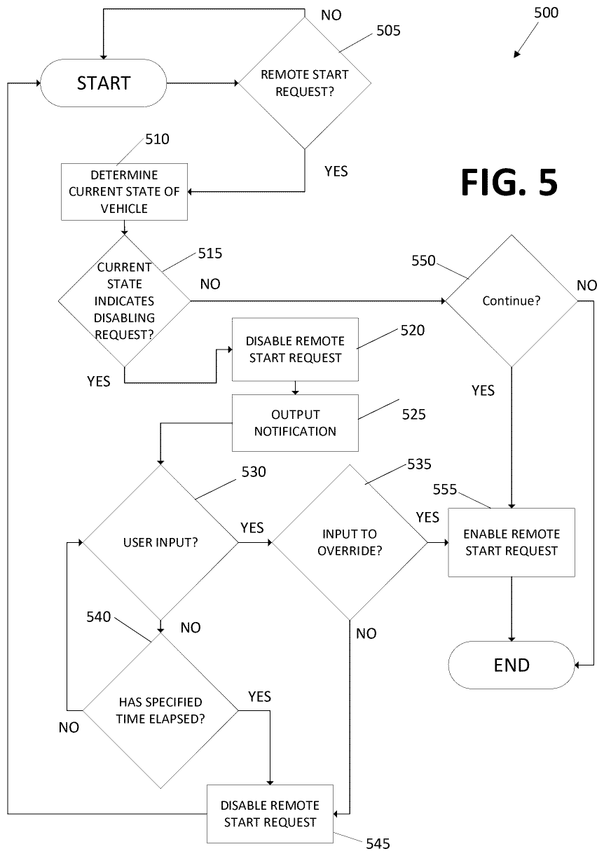

The vehicle computer 112 can store instructions executable by a processor of the computer 112 to control components of the vehicle 110, e.g., by actuating vehicle components and/or providing commands to other components or computers in the vehicle. FIG. 5 is a process flow diagram 500 of an example process 500 for the system 100, where steps of the process 500 could be carried out according to programming of the computer 112.

Referring now to FIG. 5, an example process 500 begins in a decision block 505, in which the computer 112 determines (e.g., according to programming that may be executed when a vehicle is in an off or dormant state in which the computer 112 is configured to listen for remote start requests, e.g., via the network 114) whether a remote start request has been received by the vehicle computer 112. Upon determining the remote start request is received by the vehicle computer 112, the process 500 moves to block 510. If no remote start request is received by the vehicle computer 112, the process 500 returns to its start.

With reference to block 510, the process 500 includes determining the current state of the vehicle 110.

Next, in a decision block 515, based on determining the current state, the process 500 includes determining whether the current state indicates that the remote start request should be disabled. If the current state indicates that the remote start request should be disabled, the process 500 moves to block 520. If the current state indicates that the remote start request should be enabled, the process 500 moves to block 555.

With reference to block 520, based on determining the current state of the vehicle 110 and that the current state of the vehicle 110 indicates that the remote start request should be disabled, the process 500 includes determining to disable the remote start request in the vehicle 110, i.e., the vehicle computer 112 disables the remote start request. The process 500 then continues to block 525.

With reference to block 525, in response to disabling the remote start request, the process 500 includes outputting a notification. As discussed above, the notification may be output to, e.g., the remote device 118 or to a user interface inside the vehicle 110. The notification may be available on the, e.g., the remote device 118 or user interface, and/or user input in response to the notification may be accepted, for no more than the specified time. The process 500 continues to decision block 530.

With reference to decision block 530, the process 500 includes determining whether a user input is received within the specified time. The input may include an input on a user interface. The vehicle computer 112 may receive a message that the user has provided an input to the user interface, e.g., including data based on the input, e.g., that the user has provided input to override a remote start disablement. For example, in the case of a remote device 118, the remote device may send a message to the vehicle computer 112 indicating the user input. If an input from the user is received, the process 500 moves to block 535. If no input is received, the process 500 moves to block 540.

With reference to decision block 535, based on determining that a user input was received, the process 500 includes determining if the user input was an input to override the disabling of the remote start request. Again, the vehicle computer 112 may receive a message including data provided by the user input. For example, the remote device 118 may send a message to the vehicle compute indicating that the input was an input to override the disabling of the remote start request. If the user input was an input to override the disabling of the remote start request, the process 500 moves to block 555. If the user input was not an input to override, the process 500 moves to block 545.

With reference to decision block 540, based on determining that no user input was received, the process 500 includes determining if the specified time has elapsed. If the specified time has elapsed, the process 500 moves to block 545. If the specified time has not elapsed, the process 500 returns to decision block 530 to again determine whether the user has provided an input.

With reference to block 545, upon receiving no user input to override the disabling of the remote start request or upon determining that the specified time has elapsed, the process 500 includes disabling the remote start request. After the remote start request is disabled, the process 500 returns to the block 505.

With reference to decision block 550, which may follow the block 515, the vehicle computer 112 determines whether the process 500 should continue. The process may discontinue for any suitable reason, e.g., the application of the remote device 118 shuts down, the application receives a user input to cancel the remote start request, a battery of the vehicle 110 dies, etc. If the process 500 is not to continue, the process 500 ends following the block 550. Otherwise, the process 500 moves to block 555.

With reference to block 555, upon receiving a user input to override the disabling of the remote start request or upon determining that the current state does not indicate that the remote start request may be disabled, the process 500 includes actuating one or more vehicle components according to the remote start request, the propulsion of the vehicle, vehicle heating, ventilation and air conditioning (HVAC), etc. Once the remote start request is enabled, the process 500 ends.

Executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random-access memory, etc. A computer readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer readable media include, for example, a floppy disk, a flexible disk, hard disk, magnetic tape, any other magnetic medium, a CD ROM, DVD, any other optical medium, any other physical medium with patterns of holes, a RAM, a PROM, an EPROM, a FLASH EEPROM, any other memory chip or cartridge, or any other medium from which a computer can read.

Use of “in response to,” “based on,” and “upon determining” herein, including with reference to process 500, indicates a causal relationship, not merely a temporal relationship.

The term “exemplary” is used herein in the sense of signifying an example.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The disclosure has been described in an illustrative manner, and it is to be understood that the terminology which has been used is intended to be in the nature of words of description rather than of limitation. The numerical adjectives “first” and “second” are used herein merely as identifiers and do not signify order or importance. Many modifications and variations of the present disclosure are possible in light of the above teachings, and the disclosure may be practiced otherwise than as specifically described.

1. A system, comprising:
a computer including a processor and a memory storing instructions executable by the processor to:
identify a user of a vehicle as authorized or unauthorized based on the current state of the vehicle;
determine to disable a remote start request in the vehicle based on the current state of the vehicle and the user being unauthorized;
in response to disabling the remote start request, output a notification; and then upon receiving a user input to override the disabling of the remote start request, actuate one or more vehicle components as specified by the remote start request.

2. The system of claim 1, wherein the current state of the vehicle includes a vehicle location.

3. The system of claim 2, wherein the vehicle location is an indoor location.

4. The system of claim 2, wherein the vehicle location is within a geofenced area.

5. The system of claim 1, wherein the current state of the vehicle includes a suspension height of the vehicle.

6. The system of claim 1, wherein the current state of the vehicle includes an exterior component status of the vehicle, the component status being one of attached or unattached.

7. The system of claim 1, wherein the current state of the vehicle includes a wheel attachment status.

8. (canceled)

9. The system of claim 1, wherein the user input to override the disabling of the remote start request is within a specified time.

10. The system of claim 9, wherein the specified time is determined based on the current state.

11. A method, comprising:
identifying a user of a vehicle as authorized or unauthorized based on the current state of the vehicle;
determining to disable a remote start request in the vehicle based on the current state of the vehicle and the user being unauthorized;
in response to disabling the remote start request, outputting a notification; and then upon receiving a user input to override the disabling of the remote start request, actuating one or more vehicle components as specified by the remote start request.

12. The method of claim 11, wherein the current state of the vehicle includes a vehicle location.

13. The method of claim 12, wherein the vehicle location is an indoor location.

14. The method of claim 12, wherein the vehicle location is within a geofenced area.

15. The method of claim 11, wherein the current state of the vehicle includes a suspension height of the vehicle.

16. The method of claim 11, wherein the current state of the vehicle includes an exterior component status of the vehicle, the component status being one of attached or unattached.

17. The method of claim 11, wherein the current state of the vehicle includes a wheel attachment status.

18. (canceled)

19. The method of claim 11, wherein the user input to override the disabling of the remote start request is within a specified time.

20. The method of claim 19, wherein the specified time is determined based on the current state.

21. A system, comprising:
a computer including a processor and a memory storing instructions executable by the processor to:
determine to disable a remote start request in a vehicle based on a current state of the vehicle, wherein the current state of the vehicle includes an exterior component status of the vehicle, the component status being one of attached or unattached;
in response to disabling the remote start request, output a notification; and then upon receiving a user input to override the disabling of the remote start request, actuate one or more vehicle components as specified by the remote start request.
